(19) United States
(12) Patent Application Publication
(10) Pub. No.: US 2015/0315388 A1
(43) Pub. Date: Nov. 5, 2015

(54) MULTIFUNCTIONAL COATING STRUCTURE AND METHOD FOR FORMING THE SAME

(71) Applicants: Sang Ho CHO, (US); Soon Young HONG, (US); SAMSUNG ELECTRONICS CO., LTD., Suwon-si,Gyeonggi-do (KR)

(72) Inventors: Byung Ha PARK, Suwon (KR); Soo Jin PARK, Hwaseong (KR); In Oh HWANG, Seongnam (KR); Sang Ho CHO, Ansan (KR); Soon Young HONG, Siheung (KR)

(73) Assignees: SAMSUNG ELECTRONICS CO., LTD., Suwon-si,Gyeonggi-do (KR); Sang Ho CHO, Ansan-si, Gyeonggi-do (KR); Soon Young HONG, Siheung-si, Gyeonggi-do (KR)

(21) Appl. No.: 14/648,864

(22) PCT Filed: Aug. 9, 2013
(86) PCT No.: PCT/KR2013/007210

§ 371 Date: Jun. 1, 2015

(30) Foreign Application Priority Data
Nov. 30, 2012 (KR) 10-2012-0137540

(51) Int. Cl. C09D 5/14; A01N 59/16; A01N 55/00; B05D 7/00

(52) U.S. Cl. CPC C09D 5/14; B05D 7/52; A01N 59/16; A01N 55/00

(57) ABSTRACT

Disclosed are a coating structure including an antibacterial layer formed between an article as a coating object and an anti-fingerprint coating layer to improve durability, reliability and corrosion resistance of the anti-fingerprint coating layer and provide antibacterial properties and a method for forming the same. Disclosed is a coating structure formed on a surface of an article including an antibacterial layer formed on the surface of the article, and an anti-fingerprint coating layer formed on the antibacterial layer.

### TECHNICAL FIELD

Embodiments of the present invention relate to a multifunctional coating structure with antibacterial properties and fingerprint resistance and a method for forming the same.

### BACKGROUND ART

### Cross-Reference to Related Application

This application claims the benefit of Korean Patent Application No. P2012-0137540, filed on Nov. 30, 2012, in the Korean Intellectual Property Office, the disclosure of which is incorporated herein by reference.

Surfaces of displays of electronic products, for example, screens of TVs, monitor screens of PCs or notebooks, screens of mobile equipment such as cellular phones or PDAs, or touch panels of electronic products are readily stained with fingerprints or components, such as lipids or proteins, of the face and are thus remarkably visible to the naked eye and appear dirty when coming in contact with the hands or face of users during calling.

Cosmetics, oils or hand stains adhered to heated screens or touch panels provide an environment facilitating growth and propagation of pathogenic bacteria, thus causing skin troubles and diseases deriving from Escherichia coli and staphylococcus.

In conventional methods, a thin film containing water-repellent and oil-repellent fluorine is formed on surfaces of screens or touch panels, or an anti-fingerprint coating layer is formed by coating a water-repellent silicone resin skeleton thereon.

As a conventional method for forming an anti-fingerprint coating layer, anti-glare (AG) coating, invisible-fingerprint (IF) coating or anti-fingerprint (AF) coating is generally used. First, AG coating is a method of forming fine irregularities on the surface of a panel to reduce scattered reflection and thereby obtain anti-fingerprint effects. IF coating is a method of spreading a fingerprint component during fingerprint adhesion to reduce scattered reflection and thereby obtain anti-fingerprint effects. AF coating is a method of forming a coating layer on the surface of a panel by spraying or deposition to provide easy cleaning and improve slip sensation. In particular, the IF coating or AF coating method includes depositing silicon dioxide (SiO₂) on the surface of an article for coating by vacuum deposition using an electron beam and then forming an IF or AF coating layer thereon in order to improve wear resistance.

However, such an anti-fingerprint coating is incapable of inhibiting bacterial propagation or killing bacteria when the surface thereof is contaminated by microorganisms.

### DISCLOSURE

Therefore, it is an aspect of the present invention to provide a multifunctional coating structure which includes an antibacterial layer formed between an article as a coating object and an anti-fingerprint coating layer, and thereby provides antibacterial properties while maintaining functions of the anti-fingerprint coating layer, and a method for forming the same.

Additional aspects of the invention will be set forth in part in the description which follows and, in part, will be obvious from the description, or may be learned by practice of the invention.

In accordance with one aspect of the present invention, a coating structure formed on a surface of an article includes an antibacterial layer formed on the surface of the article, and an anti-fingerprint coating layer formed on the antibacterial layer.

The antibacterial layer may have a thickness of about 50 Å to about 400 Å.

The antibacterial layer may have a thickness of about 100 Å to about 200 Å.

A composition of the antibacterial layer may contain a hydroxylated inorganic carrier-antibacterial metal complex.

The inorganic carrier may be selected from zeolite, zirconium phosphate, calcium phosphate, calcium zinc phosphate, ceramic, soluble glass powder, alumina, silicon, titanium zeolite, apatite and silica.

The antibacterial metal may include at least one selected from the group consisting of silver, zinc, copper, tin, platinum, barium, magnesium, germanium, titanium and calcium.

The composition of the antibacterial layer may contain a complex of an organic carrier having an aminosilane group and an antibacterial metal.

The organic carrier may include at least one selected from the group consisting of alginate, pectin, casein, carrageenan, polyacrylic acid, a poly(acrylic acid-vinyl alcohol) copolymer, a poly(vinylpyrrolidone-acrylic acid) copolymer, a maleic acid copolymer, polyvinylsulfate, poly(vinylsulfonic acid), polyvinyl phosphonic acid, diamine, polyamine, diethylene triamine pentaacetic acid (DTPA), tetraethylene triamine (TET), ethylenediamine (EDA), diethylene triamine (DETA), ethylene diamine tetraacetic acid (EDTA), dimethylglyoxime, polyaminocarboxylic acid, ethylene thiourea and iminourea.

The antibacterial metal may include at least one selected from the group consisting of silver, zinc, copper, tin, platinum, barium, magnesium, germanium, titanium and calcium.

The antibacterial layer may be formed by coating the hydroxylated inorganic carrier-antibacterial metal complex on the surface of the article and the complex layer of an organic carrier having an aminosilane group and an antibacterial metal on the hydroxylated inorganic carrier-antibacterial metal complex.

In accordance with another aspect of the present invention, provided is an article having a surface provided with a multifunctional coating structure, wherein the multifunctional coating structure includes an antibacterial layer formed on the surface of the article, and an anti-fingerprint coating layer formed on the antibacterial layer.

The antibacterial layer may have a thickness of about 50 Å to about 400 Å.

The antibacterial layer may have a thickness of about 100 Å to about 200 Å.

A composition of the antibacterial layer may contain a hydroxylated inorganic carrier-antibacterial metal complex.

A composition of the antibacterial layer may contain an organic carrier having an aminosilane group/antibacterial metal complex.

The antibacterial metal may include at least one selected from the group consisting of silver, zinc, copper, tin, platinum, barium, magnesium, germanium, titanium and calcium.

The antibacterial layer may be formed by coating the hydroxylated inorganic carrier-antibacterial metal complex on the surface of the article and coating the organic carrier having an aminosilane group/antibacterial metal complex on the hydroxylated inorganic carrier-antibacterial metal complex layer.

In accordance with another aspect of the present invention, a method for forming a multifunctional coating structure on a surface of an article includes forming an antibacterial layer on the surface of the article, and forming an anti-fingerprint coating layer on the antibacterial layer.

The formation of the antibacterial layer and the formation of the anti-fingerprint coating layer may be carried out by vacuum deposition.

The antibacterial layer may have a thickness of about 50 Å to about 400 Å.

The antibacterial layer may have a thickness of about 100 Å to about 200 Å.

A composition of the antibacterial layer may contain a hydroxylated inorganic carrier-antibacterial metal complex.

The composition of the antibacterial layer may contain an organic carrier having an aminosilane group-antibacterial metal complex.

The antibacterial metal may include at least one selected from the group consisting of silver, zinc, copper, tin, platinum, barium, magnesium, germanium, titanium and calcium.

The antibacterial layer may be formed by coating the hydroxylated inorganic carrier-antibacterial metal complex on the article and then coating an organic carrier having an aminosilane group-antibacterial metal complex on the hydroxylated inorganic carrier-antibacterial metal complex.

### DESCRIPTION OF DRAWINGS

These and/or other aspects of the invention will become apparent and more readily appreciated from the following description of the embodiments, taken in conjunction with the accompanying drawings of which:

FIG. 1 is a sectional view schematically illustrating an anti-fingerprint coating structure formed on an article surface by a conventional method;

FIG. 2 is a sectional view schematically illustrating a multifunctional coating structure according to an embodiment of the present invention;

FIG. 3A illustrates an antibacterial layer obtained by coating a hydroxylated inorganic carrier-antibacterial metal complex, formed on a substrate;

FIG. 3B illustrates an antibacterial layer obtained by coating an organic carrier-antibacterial metal complex having an aminosilane group, formed on a substrate;

FIG. 4 shows images of viable Escherichia coli colonies of a sample of the conventional anti-fingerprint coating structure of FIG. 1 and of a sample of the coating structure according to an embodiment of the present invention, obtained after inoculating the samples with Escherichia coli and culturing for 24 hours regarding;

FIG. 5 is a flowchart illustrating a method for forming the coating structure according to an embodiment of the present invention in brief;

FIG. 6 illustrates a vacuum deposition process, as an example of a dry process for film formation;

FIG. 7 illustrates examples of a wet process for film formation; and

FIG. 8 is a flowchart illustrating a method for forming the coating structure according to the embodiment of the present invention by vacuum deposition.

### BEST MODE

Hereinafter, embodiments of the present invention will be described with reference to the accompanying drawings.

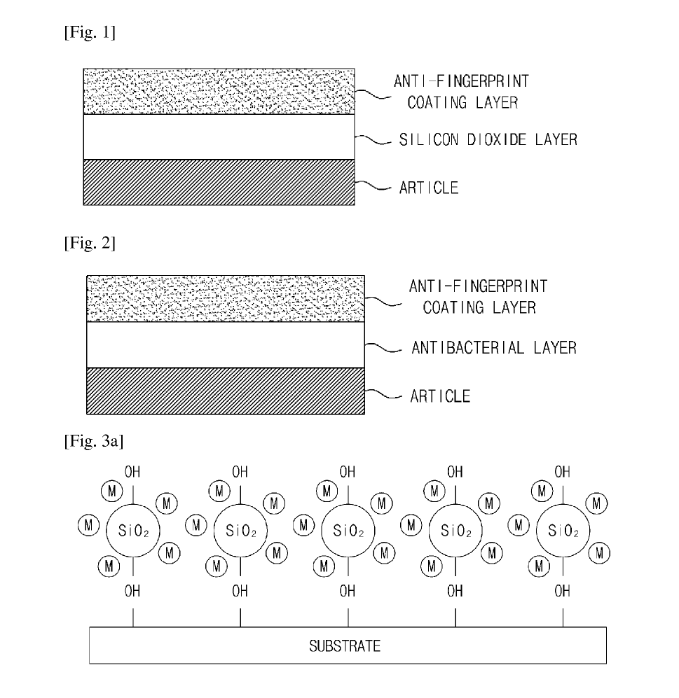

FIG. 1 is a sectional view schematically illustrating an anti-fingerprint coating structure formed on an article surface by a conventional method.

Referring to FIG. 1, in the conventional method, the anti-fingerprint coating structure to protect the article surface and prevent fingerprints is formed by coating a silicon dioxide (SiO₂) layer on the article surface and coating an anti-fingerprint coating layer thereon.

Coating with the silicon dioxide layer serves to improve durability and wear resistance through bonding between the anti-fingerprint coating layer and the silicon dioxide layer. However, this anti-fingerprint coating has no antibacterial effects capable of inhibiting bacterial propagation or killing bacteria when the surface thereof is contaminated with microorganisms.

FIG. 2 is a sectional view schematically illustrating a multifunctional coating structure according to an embodiment of the present invention.

Referring to FIG. 2, the multifunctional coating structure 100 according to an embodiment of the present invention includes an antibacterial layer formed on the surface of an article to be coated, and an anti-fingerprint coating layer (hereinafter, referred to as an “anti-fingerprint coating layer”) formed on the antibacterial layer. That is, the multifunctional coating structure 100 according to the embodiment of the present invention provides the antibacterial layer, instead of a silicon dioxide (SiO₂) layer which merely improves bonding strength between the article surface and the anti-fingerprint coating composition, thereby exerting not only bonding strength therebetween but also antibacterial properties.

The article to be coated includes, but is not limited to, cellular phones, portable terminals such as PDAs, and display devices such as TVs or computer monitors. Any article may be used without limitation so long as the surface thereof may be stained with foreign matter such as fingerprints or a coating layer may be formed on the surface thereof upon use.

In addition, the article surface on which the coating structure is formed includes, but is not limited to, a surface of a touchscreen panel or a surface of an LCD, LED or the like. Any article surface may be used so long as the surface thereof may be stained with foreign matter such as user's fingerprints or a coating layer may be formed on the surface thereof upon use.

In one embodiment, the composition of the antibacterial layer may contain a hydroxylated inorganic carrier-antibacterial metal complex.

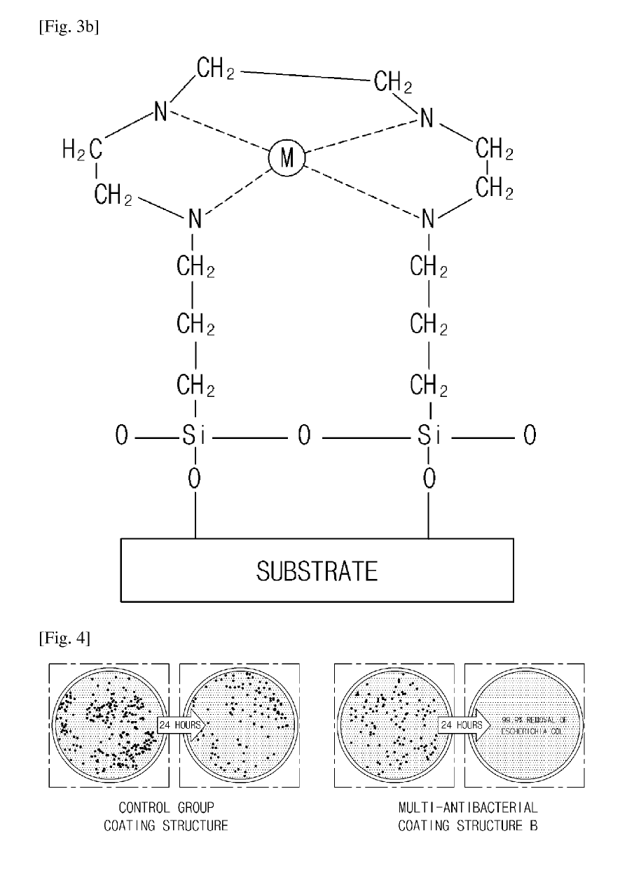

FIG. 3A illustrates an antibacterial layer obtained by coating a hydroxylated inorganic carrier-antibacterial metal complex, formed on a substrate. In FIG. 3A, alphabet “M” represents an antibacterial metal and hydroxylated silica is shown as an example of a hydroxylated inorganic carrier.

Examples of the inorganic carrier include, but are not limited to, zeolite, zirconium phosphate, calcium phosphate, calcium zinc phosphate, alumino phosphate, ceramic, soluble glass powder, alumina, silicon, titanium zeolite, apatite, silica and carbon nanotubes (CNTs). Any inorganic carrier may be used without limitation so long as it has porosity and bonds to an antibacterial metal through ion exchange.

In general, the inorganic carrier bonds to the antibacterial metal through ion exchange to form an inorganic carrier-antibacterial metal complex, which is used as an antibacterial agent. However, when the inorganic carrier-antibacterial metal is coated on the article surface to form an antibacterial layer and an anti-fingerprint coating layer is formed thereon, bonding strength between the antibacterial layer and the anti-fingerprint coating layer is weak and the coating is not maintained.

Therefore, the present inventors discovered that superior bonding strength is provided by hydroxylating an inorganic carrier, that is, forming hydroxyl groups on the inorganic carrier, and then forming the antibacterial layer using a composition containing an inorganic carrier-antibacterial metal complex. Any method for hydroxylating an inorganic carrier well known in the technical field to which the invention pertains may be used. As an example of hydroxylation of the inorganic carrier, the inorganic carrier and silica were mixed in a ratio of 1:1 under stirring and baked to obtain a hydroxylated inorganic carrier.

By hydroxylating both an inorganic carrier containing no hydroxyl group and an inorganic carrier containing a hydroxyl group, bonding strength between the article and the anti-fingerprint coating is improved.

In another embodiment, the composition of the antibacterial layer may contain an organic carrier having an aminosilane group-antibacterial metal complex.

FIG. 3B illustrates an antibacterial layer obtained by coating an organic carrier having an aminosilane group-antibacterial metal complex, formed on a substrate. In FIG. 3B, the alphabet M represents an antibacterial metal and a silyl ligand is shown as an example of the organic carrier having an aminosilane group.

In addition, examples of the organic carrier include, but are not limited to, alginate, pectin, casein, carrageenan, polyacrylic acid, a poly(acrylic acid-vinyl alcohol) copolymer, a poly(vinyl pyrrolidone-acrylic acid)copolymer, a maleic acid copolymer, polyvinylsulfate, poly(vinylsulfonic acid), polyvinyl phosphonic acid, diamine, polyamine, diethylene triamine pentaacetic acid (DTPA), tetraethylenetriamine (TET), ethylenediamine (EDA), diethylene triamine (DETA), ethylene diamine tetraacetic acid (EDTA), dimethylglyoxime, polyamino carboxylic acid, ethylene thiourea and iminourea.

In general, the organic carrier coordinate-bonds to an antibacterial metal to form an organic carrier-antibacterial metal complex, which is used as an antibacterial agent. However, when the antibacterial layer is formed by coating the organic carrier-antibacterial metal on an article surface, there is a problem in that the organic carrier-antibacterial metal does not bond to the article surface.

Therefore, the present inventors discovered that an antibacterial layer using the organic carrier-antibacterial metal complex in which an aminosilane group is introduced into the organic carrier obtained by modifying the organic carrier with the aminosilane group exhibits superior bonding strength to article surfaces.

When the aminosilane group is introduced into the organic carrier, an amine group (—NH₂) improves bonding strength to the antibacterial metal through coordinate bonding to the antibacterial metal and a silane group improves bonding strength to the surface of articles such as glass.

The introduction of the aminosilane group into the organic carrier may be carried out by reacting the organic carrier with aminosilane by a method well-known in the art. For example, the introduction of the aminosilane group into the organic carrier may be carried out by mixing the organic carrier with aminosilane in a weight ratio of 1:1, while stirring.

Examples of the aminosilane include, but are not limited to, 3-aminopropyltrimethoxysilane, 3-aminopropyltriethoxysilane, N-(2-aminoethyl)-3-aminopropyl-trimethoxysilane, N-(2-aminoethyl)-3-aminopropyl-methyldimethoxysilane, N-(2-aminoethyl)-3-aminopropyl-triethoxysilane and N-(2-aminoethyl)-3-aminopropyl-triisopropoxysilane.

There is no limitation as to a method for forming the hydroxylated inorganic carrier-metal complex. For example, the hydroxylated inorganic carrier is dispersed in distilled water to obtain a slurry, pH of the slurry is adjusted to 5 to 8 with a dilute aqueous acidic solution, and an aqueous solution of antimicrobial metal ions is slowly added to the slurry, followed by stirring to perform an ion exchange reaction. The slurry is filtered, dried and ground to prepare a hydroxylated inorganic carrier-metal complex.

In addition, there is no limitation as to a method for preparing the organic carrier having an aminosilane group-antibacterial metal complex. For example, an organic carrier having an aminosilane group is mixed with an antibacterial metal in water while stirring to form coordinate bond therebetween, and the resulting product is filtered, dried and ground to prepare an organic carrier having an aminosilane group-antibacterial metal complex.

In addition, the antibacterial layer may be formed by coating the surface of the article with the hydroxylated inorganic carrier-metal complex, and coating the inorganic carrier-metal complex layer with the organic carrier having an aminosilane group-antibacterial metal complex.

In this case, the coating layer of the hydroxylated inorganic carrier-metal complex serves as an antibacterial layer and as a primer layer of the coating layer of the organic carrier-antibacterial metal complex.

Examples of the antibacterial metal which forms a complex with the inorganic carrier or organic carrier include, but are not limited to, silver, zinc, copper, tin, platinum, barium, magnesium, germanium, titanium, and calcium. Alternatively, the antibacterial metal may be silver, zinc or copper.

An antibacterial mechanism of this antibacterial metal is assumed to be as follows: \textcircled{1} released metal ions under a wet atmosphere bond to bacterial proteins and destroy bacterial cells and thereby inhibit bacterial propagation or kill bacteria; and \textcircled{2} oxygen in air and oxygen dissolved in water are changed into active oxygen through catalytic action of metals, thus causing damage to a surface structure of bacteria. Advantageously, the antibacterial metal maintains an antibacterial effect during use period of the article.

In a case in which zinc is used as the antibacterial metal, zinc may be used in the form of zinc acetate, zinc oxide, zinc carbonate, zinc hydroxide, zinc chloride, zinc sulfate, zinc citrate, zinc fluoride, zinc iodide, zinc lactate, zinc oleate, zinc oxalate, zinc phosphate, zinc propionate, zinc salicylate, zinc selenate, zinc silicate, zinc stearate, zinc sulfide, zinc tannate, zinc tartrate, zinc valerate, zinc gluconate, and zinc undecylenate. In addition, a combination of these zinc salts may be used.

In addition, in a case in which copper is used as the antibacterial metal, the copper may be used in the form of copper (II) sodium citrate, copper triethanolamine, copper carbonate, copper (I) carbonate ammonium, copper (II) hydroxide, copper chloride, copper (II) chloride, a copper ethylene diamine complex, copper oxychloride, copper oxychloride sulfate, copper (I) oxide, copper thiocyanate or the like. In addition, a combination of these copper salts may be used.

In addition, in a case in which silver is used as the antibacterial metal, the silver may be used in the form of silver nitrate, silver sulfate, silver perchlorate, silver acetate, diamine silver nitrate or diamine silver sulfate.

A content of the antibacterial metal in the carrier-antibacterial metal complex may be 0.05 to 10% by weight. When the content of these metal ions is lower than the lower limit, it is impossible to obtain effective antibacterial properties and when the content thereof exceeds the upper limit, further improvement in antibacterial properties is not obtained and an insoluble metal salt is precipitated on the surface of the carrier, thus causing problems such as deterioration in antibacterial properties and discoloration.

It is necessary to suitably control a thickness of the formed antibacterial layer. When the thickness of the antibacterial layer is less than 50 Å, coating uniformity is deteriorated. The thickness of the antibacterial layer may be 50 Å or more. The term “uniformity” means that performance associated with strength or deformation of a structure is present in a substantially identical level and does not include localized weaknesses. In addition, when the thickness of the antibacterial layer exceeds 400 Å, coating qualities are deteriorated and reliability is lowered. Accordingly, the thickness of the antibacterial layer may be 400 Å or less.

Accordingly, in one embodiment of the present invention, in view of both antimicrobial properties and reliability of the coating structure, the thickness of the antibacterial layer may be controlled to 50 Å to 400 Å. When the thickness of the antibacterial layer is 100 Å to 200 Å, it is possible to obtain a coating structure with superior antimicrobial properties and reliability.

Hereinafter, a measurement result of anti-fingerprint and antibacterial effects of the coating structure according to an embodiment of the present invention will be described with reference to Table 1.

Regarding a coating structure (A) obtained by forming an antibacterial layer containing a hydroxylated inorganic carrier-antibacterial metal complex, for example, a hydroxylated zeolite-Ag complex, on an article surface and then forming a silicon-based (IF) anti-fingerprint coating layer thereon, and a coating structure (B) obtained by forming an antibacterial layer containing an organic carrier having an aminosilane group-antibacterial metal complex, for example, an EDTA having an aminosilane group-Ag complex, and forming a fluorine-based (AF) anti-fingerprint coating layer, anti-fingerprint and antibacterial effects are measured. In addition, anti-fingerprint and antibacterial effects of a silicon-based (IF) anti-fingerprint coating layer formed on a conventional silicon dioxide layer and a fluorine-based (AF) anti-fingerprint coating layer as control groups are measured.

In order to describe anti-fingerprint effects of the coating structure, Table 1 shows measurement results of initial contact angles (water contact angle (DI), diiodomethane contact angle (DM)) at 35° C. of the coating structure of FIG. 1 and the coating structure of FIG. 2 as described above and measurement results of slippage (coefficient of kinetic friction).

Contact angle means a predetermined angle formed between a flat solid surface and a liquid surface, when a droplet of a liquid is placed on the solid surface and forms a drop maintaining a predetermined lens shape, which depends on the types of liquid and solid.

Coefficient of kinetic friction means a resistant force corresponding to a force required for which one surface moves on another surface contacting the same at a predetermined speed, which is used as a parameter indicating slippage of a coating film. Measurement of coefficient of kinetic friction is carried out at 23° C. and at a relative humidity of 50%.

Measurement of antimicrobial properties is carried out using Escherichia coli and Staphylococcus aureus as Gram-negative bacteria in accordance with JIS Z 2801 standard film attached method. All specimens are inoculated with test bacteria and are then cultured at 35±1° C., at a relative humidity of 90% or longer for 24±1 hours. Bacteria are collected from the specimens, the number of viable bacteria is measured, and bacteria decrease proportion (%) and bacteria removal proportion (%) are calculated.

TABLE 1

| | | Control | | Control | |
|---|---|---|---|---|---|
| | | group IF | A | group AF | B |
| Contact angle (DI/DM) | | 70/45 | 70/45 | 115/95 | 115/95 |
| Slippage (kinetic coefficient of | | 0.4 | 0.4 | 0.1 | 0.1 |
| friction) | | | | | |
| Antibacterial | Bacteria decrease | 71.8 | >99.9 | 62.9 | >99.9 |
| properties | proportion (%) | | | | |
| (E. coli) | Bacteria removal | NG | >99.9 | NG | >99.9 |
| | proportion (%) | | | | |
| Antibacterial | Bacteria decrease | 70.90 | >99.9 | 60.8 | >99.9 |
| properties | proportion (%) | | | | |
| (S. aureus) | Bacteria removal | NG | >99.9 | NG | >99.9 |
| | proportion (%) | | | | |

As can be seen from Table 1 above, the coating structures A and B according to the embodiment of the present invention maintain basic properties (initial contact angle and slippage) of the anti-fingerprint coating layer and have an antibacterial function through the antibacterial layer, thus having multiple functions including fingerprint resistance and antibacterial properties. The coating structures A and B exhibit high antibacterial properties to E. coli and S. aureus, as public bacteria, and more specifically, bacteria decrease proportion and bacteria removal proportion of 99.9% or more, FIG. 4 shows images of viable Escherichia coli colonies of a sample for the control group AF and the antibacterial AF sample of the coating structure B according to an embodiment of the present invention shown in Table 1, obtained after inoculating with Escherichia coli and culturing for 24 hours. From FIG. 4, it is seen that the antibacterial AF sample of the coating structure according to the embodiment of the present invention has the number of viable Escherichia coli of 10 or less, which means that most of Escherichia coil is removed.

The coating structure according to an embodiment of the present invention contains both an antibacterial layer and an anti-fingerprint coating layer. A thin film containing a water-repellent and oil-repellent fluorine or a thin film containing a water-repellent silicone resin skeleton generally used as an anti-fingerprint thin film may be used as a material for the anti-fingerprint coating layer, but the embodiments of the present invention are not limited thereto. Various coating materials may be used as the anti-fingerprint coating layer depending on article application.

The term “anti-fingerprint” herein used includes prevention of fingerprint staining, easy removal of fingerprints and hiding of stained fingerprint.

The fluorine-based compound has a considerably low surface energy of about 5 to 6 dyne/cm, thus exhibiting functions such as water repellency, oil-repellency, chemical resistance, lubricity, release property and anti-staining property.

The silicon compound has low intermolecular attraction, low surface tension, high spreadability on a substrate surface and thus excellent water-repellency.

In addition, so as to improve water-repellency and oil-repellency, the silicon compound may be used in combination with a fluorine-based compound.

Hereinafter, a method for forming the coating structure according to an embodiment of the present invention will be described.

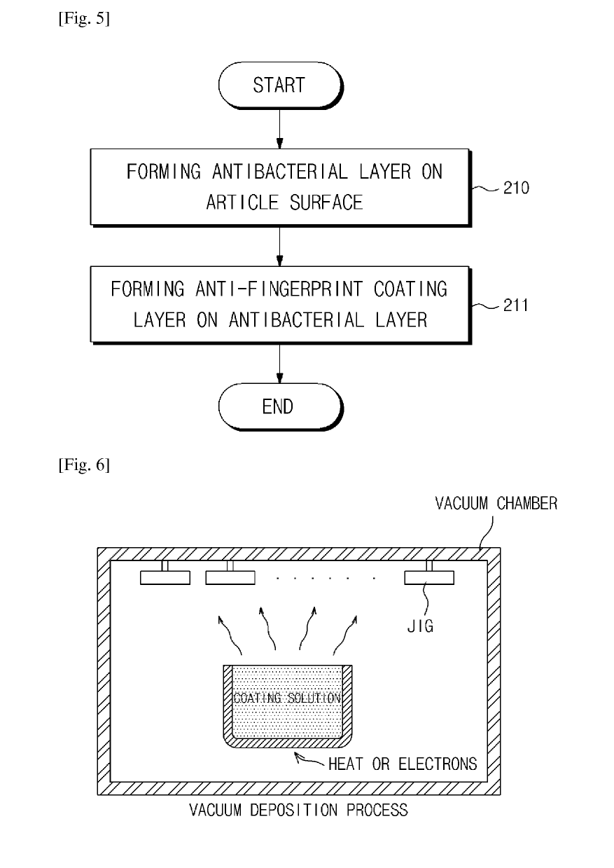

FIG. 5 is a flowchart illustrating the method for forming the coating structure according to an embodiment of the present invention in brief.

Referring to FIG. 5, the method for forming the coating structure according to an embodiment of the present invention includes forming an antibacterial layer on a surface of an article to be coated (210) and forming an anti-fingerprint coating layer on the antibacterial layer (211).

Hereinafter, formation methods of the respective layers will be described in detail.

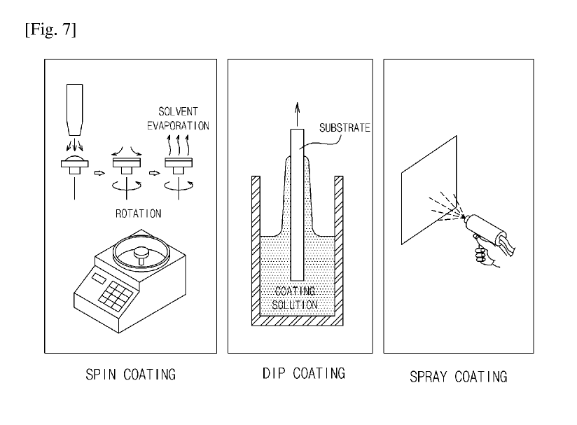

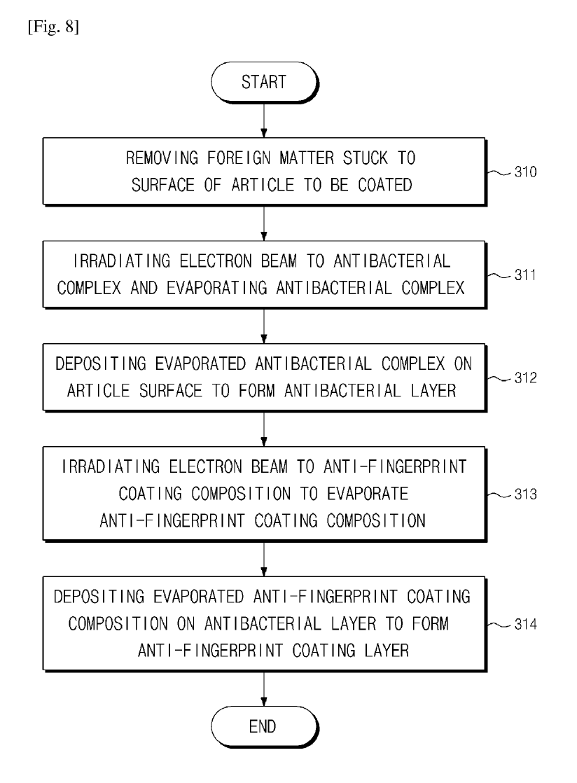

FIG. 6 illustrates a vacuum deposition process as an example of a dry process for film formation and FIG. 7 illustrates examples of a wet process for film formation.

Referring to FIG. 6, vacuum deposition may be used as a dry process for forming a film to a display portion or a touch panel of an electrical product.

Vacuum deposition means a method of forming a thin film on an opposite surface facing an evaporation source by evaporating a metal or compound under vacuum. An example of the vacuum deposition process is given as follows. A jig is mounted on a vacuum chamber, a substrate is mounted thereon such that the surface thereof to be coated faces downward, and a bath containing a coating solution is placed on the chamber bottom facing the substrate. When heat or an electron beam is applied to the bath to evaporate the coating solution, the evaporated coating solution is deposited on the surface of the substrate mounted on the jig to form a thin film.

Referring to FIG. 7, dip coating, spin coating or spray coating may be used as a wet process for forming a thin film on the surface of a substrate of an electrical product using a coating composition present as a solution state.

Dip coating is a method including dipping a substrate of an electrical product in a coating solution for a predetermined time and evaporating a solvent component, which is generally used for coating a substrate having an irregular surface. Dip coating may be applied depending on a substrate of an electrical product, as a coating object.

Spin coating is a method for forming a thin film including spraying a coating solution on a rotating substrate, followed by drying and thermal treatment, which is generally used for formation of a thin film. Spin coating is a method for forming a thin film based on the principle that a liquid placed on an object is forced out based on centrifugal force by rotating the object by a spin-coater. A material for coating may be dissolved in a solvent or present in a liquid state.

Spray coating is a method for spraying a coating solution having a low viscosity through a spray nozzle. This method enables a thin film to be uniformly formed even on a substrate having an irregular or rough surface and uses a smaller amount of coating solution, as compared to dip coating, since the coating solution is applied only to one surface of the substrate and reduces energy required for evaporation.

The coating structure according to the embodiment of the present invention may be coated by vacuum deposition. Furthermore, a dry or wet process other than vacuum deposition may be used.

Hereinafter, a method for forming a coating structure according to one embodiment of the present invention by vacuum deposition will be described in detail.

FIG. 8 is a flowchart illustrating a method for forming the coating structure according to one embodiment of the present invention by vacuum deposition.

Referring to FIG. 8, first, foreign matter or dirt stuck to the surface of the article to be coated are removed (310). At this time, either argon (Ar) plasma cleaning or ionized air blowing may be used. The article to be coated is arranged on a jig, is set using a magnet and subjected to ionized air blowing. As a result, foreign matter or moisture present on the surface thereof is sufficiently removed and the surface of the article is activated, thus facilitating deposition. In addition, the article in which foreign matter is removed is mounted on a vacuum chamber and deposition conditions such as crucible position and deposition thickness are determined.

A hydroxylated inorganic carrier-antibacterial metal complex or an organic carrier having an aminosilane group-antibacterial metal complex (hereinafter, referred to as an “antibacterial complex”) is placed in a crucible and a vacuum deposition machine is operated. At this time, an electron beam is irradiated to the antibacterial complex and the antibacterial complex is evaporated (311). The evaporated antibacterial complex is deposited on the article surface to form an antibacterial layer (312). At this time, the deposition thickness of the antibacterial layer may be 50 to 400 Å or 100 to 200 Å.

After formation of the antibacterial layer, an anti-fingerprint coating composition is placed in a crucible and an electron beam is irradiated to the anti-fingerprint coating composition to evaporate the anti-fingerprint coating composition (313). The evaporated anti-fingerprint coating composition is deposited on the antibacterial layer to form an anti-fingerprint coating layer (314). An AF coating composition such as a fluorine-based or silicon-based composition, or an IF coating composition such as a fluorine-based or silicon-based composition may be used as the anti-fingerprint coating composition. The anti-fingerprint coating composition is not limited to the embodiments of the present invention.

According to the coating structure and the method for forming the same according to one embodiment of the present invention, by forming an antibacterial layer between an article as a coating object and an anti-fingerprint coating layer, durability, reliability and corrosion resistance of the anti-fingerprint coating layer is improved and antibacterial properties is provided. That is, growth and propagation of various bacteria derived from saliva and lung secretions of a user and harmful bacteria floating in air on an article surface are efficiently prevented through an antibacterial metal having superior antibacterial properties, and user satisfaction is thus advantageously maximized through use of hygienic products and prevention of skin allergies or troubles.

Although a few embodiments of the present invention have been shown and described, it would be appreciated by those skilled in the art that changes may be made in these embodiments without departing from the principles and spirit of the invention, the scope of which is defined in the claims and their equivalents.

1. A coating structure formed on a surface of an article comprising:
an antibacterial layer formed on the surface of the article; and
an anti-fingerprint coating layer formed on the antibacterial layer.

2. The coating structure according to claim 1, wherein the antibacterial layer has a thickness of about 50 Å to about 400 Å, or preferably about 100 Å to about 200 Å.

3. The coating structure according to claim 1, wherein a composition of the antibacterial layer comprises a hydroxylated inorganic carrier-antibacterial metal complex.

4. The coating structure according to claim 3, wherein the inorganic carrier is selected from zeolite, zirconium phosphate, calcium phosphate, calcium zinc phosphate, ceramic, soluble glass powder, alumina, silicon, titanium zeolite, apatite and silica.

5. The coating structure according to claim 1, wherein the composition of the antibacterial layer comprises a complex of an organic carrier having an aminosilane group and an antibacterial metal.

6. The coating structure according to claim 5, wherein the organic carrier comprises at least one selected from the group consisting of alginate, pectin, casein, carrageenan, polyacrylic acid, a poly(acrylic acid-vinyl alcohol) copolymer, a poly(vinylpyrrolidone-acrylic acid) copolymer, a maleic acid copolymer, polyvinylsulfate, poly(vinylsulfonic acid), polyvinyl phosphonic acid, diamine, polyamine, diethylene triamine pentaacetic acid (DTPA), tetraethylene triamine (TET), ethylenediamine (EDA), diethylene triamine (DETA), ethylene diamine tetraacetic acid (EDTA), dimethylglyoxime, polyaminocarboxylic acid, ethylene thiourea and iminourea.

7. The coating structure according to claim 1, wherein the antibacterial layer has a two layer structure including a hydroxylated inorganic carrier-antibacterial metal complex layer formed on the surface of the article and a complex layer of an organic carrier having an aminosilane group and an antibacterial metal formed on the hydroxylated inorganic carrier-antibacterial metal complex layer.

8. The coating structure according to any one of claim 3, wherein the antibacterial metal comprises at least one selected from the group consisting of silver, zinc, copper, tin, platinum, barium, magnesium, germanium, titanium and calcium.

9. A method for forming a multifunctional coating structure on a surface of an article comprising:
forming an antibacterial layer on the surface of the article; and
forming an anti-fingerprint coating layer on the antibacterial layer.

10. The method according to claim 9, wherein the formation of the antibacterial layer and the formation of the anti-fingerprint coating layer are carried out by vacuum deposition.

11. The method according to claim 9, wherein the antibacterial layer has a thickness of about 50 Å to about 400 Å or preferably about 100 Å to about 200 Å.

12. The method according to claim 9, wherein a composition of the antibacterial layer comprises a hydroxylated inorganic carrier-antibacterial metal complex.

13. The method according to claim 9, wherein the composition of the antibacterial layer comprises an organic carrier having an aminosilane group-antibacterial metal complex.

14. The method according to claim 9, wherein the antibacterial layer has a two layer structure obtained by coating the hydroxylated inorganic carrier-antibacterial metal complex on the surface of the article and coating the complex layer of an organic carrier having an aminosilane group and an antibacterial metal formed on the hydroxylated inorganic carrier-antibacterial metal complex layer.

15. The method according to any one of claim 12, wherein the antibacterial metal comprises at least one selected from the group consisting of silver, zinc, copper, tin, platinum, barium, magnesium, germanium, titanium and calcium.
